(19) United States
(12) Patent Application Publication
(10) Pub. No.: US 2018/0073855 A1
(43) Pub. Date: Mar. 15, 2018

(54) NOVEL SENSOR FOR MONITORING DIRECT AND REALTIME MEASUREMENT OF FRICTION BETWEEN TIRE AND ROAD FOR DRIVER AND DRIVERLESS VEHICLE APPLICATIONS

(71) Applicants: KAAMRAN RAAHEMIFAR, Kitchener-Waterloo (CA); Ehsan Marzbanrad, KITCHNER-WATERLOO (CA)

(72) Inventors: KAAMRAN RAAHEMIFAR, Kitchener-Waterloo (CA); Ehsan Marzbanrad, KITCHNER-WATERLOO (CA)

(21) Appl. No.: 15/264,105

(22) Filed: Sep. 13, 2016

(51) Int. Cl. G01B 7/24; G07C 5/00; G01L 1/12; G01M 17/02

(52) U.S. Cl. CPC G01B 7/24; G01M 17/02; G01L 1/125; G07C 5/008

(57) ABSTRACT

This device employs 3D and/or 2D magnetic field measurement sensors and an array of magnets embedded in the tire, to provide information regarding the shear strain induced in tire at the contact area between the tire and the road by friction and compressive strain in the tire due to vertical load applied on the tire, and the data is transmitted wirelessly to a receiver. The device is an ultra-low power, one-way communication, magnetic tire monitoring multi-sensor system, a microprocessor, a signal amplifier, signal filtering, using error correction algorithms, an analog-to-digital converter and a wireless electromagnetic data transmitter to transmit to a remote receiver for further processing, using a computer network and wireless access points in fixed locations. The collected data is then employed to measure the real time friction coeffcient between the tire and the road during rotation of the tire when the sensor is in contact with the road. The device is powered by rechargeable battery via DC power supply from the vehicle. The device is placed near the tire surface for sensor measurement. Abrasion of the tire will be monitored by the sensor and it will be able to work during the whole standard life of the tire. Instantaneous and continuous data collection are possible. The data collected will be ready to transfer to an ECU (Electronic Control Unit) of a car to use as indication of the road condition for control proposes of conventional vehicles, as well as in autonomous (driver-less/computer controlled) vehicles.

### FIELD OF THE DISCLOSURE

This device employs 3D and/or 2D magnetic field measurement sensors and an array of magnets embedded in the tire, to provide information regarding the shear strain induced in tire at the contact area between the tire and the road by friction and compressive strain in the tire due to vertical load applied on the tire, and the data is transmitted wirelessly to a receiver. The device is an ultra-low power, one-way communication, magnetic tire monitoring multi-sensor system, a microprocessor, a signal amplifier, signal filtering, using error correction algorithms, an analog-to-digital converter and a wireless electromagnetic data transmitter to transmit to a remote receiver for further processing, using a computer network and wireless access points in fixed locations. The collected data is then employed to measure the real time friction force between the tire and the road during rotation of the tire when the sensor is in contact with the road. The device is powered by rechargeable battery via DC power supply from the vehicle. The device is placed near the tire surface for sensor measurement. Abrasion of the tire will monitored by the sensor and it will be able to work during the whole standard life of the tire. Instantaneous and continuous data collection are possible. The device can be installed inside the tire and the device will perform measurements during the normal performance of the vehicle. The data collected will be ready to transfer to an ECU (Electronic Control Unit) of a car to use as indication of the road condition for control proposes of conventional vehicles, as well as in driver-less (computer controlled) vehicles.

### BACKGROUND

Understanding the Measurements:

In the case of the magnets fixed inside a moving in a vehicle tire, the sensors will detect any magnetic field change that produced in the array of magnets by shear action of the tire patch resulting from friction between the tire and the road, hundreds or thousands of times per second. During the rotation of the tire, depending on the position of the sensor on tire patch, the device will produce a waveform signal. Data will be extracted from this waveform signal, then it will be transferred to the microprocessor system. The sensor data will be suitably amplified, filtered and error corrected, to improve signal quality. The device will be calibrated, by performing a standard test equipment which measures the friction coefficient.

During normal driving and daily use, the car tire will be subjected to a variety of forces, namely, friction, distortion, heat and irregularities in the road surface. Theses variables are of interest, to monitor for perturbations from a normal “cycle”. The device will determine friction between the road and tire independent from all above mentioned parameters. The device will provide accurate information regarding acceleration, velocity, turning direction, direction of wheel movement (e.g. to front or to rear), shearing forces (sudden jerking of the tire in different directions), and whether the tire is making contact with the edge of a road.

This device has applications for self-driving vehicles. The device can be incorporated into the vehicle stabilization and driving computer systems in future vehicles.

The device will collect the following data from a tire: 1) information regarding the shear strain induced in tire at the contact area between the tire and the road by friction and; 2) compressive strain in the tire due to vertical load applied on the tire.

Previous Attempts by Others:

Tire Motion and Vehicle Sensor Systems

As indicated in Prior Art. the following vehicle motion, vehicle stabilization and tire pressure sensor systems attempt to provide suitable information required for a microprocessor system to calculate operation within safety requirements and/or activation of emergency warnings when data is beyond the safety parameters for the sensor system.

In one example, (U.S. Pat. No. 7,832,264, USA, 2005, Suzuki et al) “a wheel housing contains are reflection plate at a position different from that of a sensor control unit. A transmission electromagnetic field from the sensor control unit is reflected by the metal reflection plate and transmitted to a sensor unit rotated to a position to which the field does not readily reach directly from the sensor control unit. The sensor unit varies an impedance of a coil antenna in accordance with transmission data, and generates a variation in the transmission electromagnetic field. The variation is detected via the reflection plate as a variation in a transmission load of the sensor control unit, and the transmission data from the sensor unit is detected in the sensor control unit.” For the purposes of measuring the shear strain induced in tire at the contact area between the tire and the road by friction and compressive strain in the tire due to vertical load applied on the tire, this approach was not practical.

In another example (U.S. Pat. No. 7,859,393, USA, 2006, Suzuki et al.), wireless electromagnetic field transmissions between a sensor mounted on the inside surface of a tire and control unit mounted on the vehicle body are used to determine the state of the tire. Unfortunately, for the reasons indicated in the previous 5 examples, incorporating sensors into the tire rubber was impractical for our purposes.

In another example (U.S. Pat. No. 8,037,745, USA, 2009, Yang et al.), a tire pressure monitoring system includes a sensor mounted directly onto the tire pressure valve, with a sensor providing wireless communication to the vehicle computer to relay tire pressure data to a driver. This method is also impractical for our purposes, for reasons identical to the two previous examples above.

In another example (U.S. Pat. No. 7,180,409, USA, 2005, Brey), an RFID tag system is integrated with a tire belt or tread at multiple wear points. If the RFID fails to relay information to the vehicle computer, then it can be assumed that the tire is wearing down to an unsafe level and the tire is need of repair or replacement. The RFID is energized wirelessly and relays information wirelessly to the vehicle computer. Once again, for reasons identical to those in the previous 3 examples, this method was impractical for our purposes.

In another example (U.S. Pat. No. 5,749,984, USA, 1995, Frey et al.) measures the “amount of deflection of a pneumatic tire wherein said monitoring system in the tire detects tire sidewall deflection by measuring the length of the tire contact patch area relative to the total circumference of the tire. The embedded sensor device generates a signal.” This method was also determined to be insufficient for the purposes of measuring the shear strain induced in tire at the contact area between the tire and the road by friction and compressive strain in the tire due to vertical load applied on the tire, this approach was not practical.

In another example (U.S. Pat. No. 6,367,528, USA, 2000, Colantonio et al.), a tire assembly (tire, rim) including an air bladder, belt and alarm system, were only relative to tire air pressure and the activation of an alarm in the event of sudden tire decompression. This system provides no additional information regarding the tire shear strain due to friction and it provides limited information regarding compressive strain based upon a load applied to a tire, but not sufficient for accurate measurement in daily use. The method was not sufficient for our purposes.

In another example (U.S. Pat. No. 7,716,977, USA, 2008, Andonian et al.), a tire sensor is mounted radially inward within the tire casing and a tire tread ring containing a sensor is mounted radially outward tire tread. Given the degree of movement and road-induced vibration, including abrupt physical shocking to the sensor, will result in a short life-span for the sensor and it provides insufficient tire strain and compression data. Therefore, this method of mounting the sensor to the surface of the moving wheel, is impractical.

In another example (U.S. Pat. No. 6,952,954, USA, 2004, Liebemann et al.), a continuous monitoring system for a tire will measure the transmitted force and coefficient of friction potential. In this patent, a “plurality of sensors” were placed at the outer edge of the tire. This method would be used to determine the instantaneous force of the vehicle. The data was relayed wirelessly to the vehicle computer system. This method was interesting in an attempt to collect sensor data for tire friction however, tire-mounted sensors are impractical for our purposes, given the reasons for the previous 4 examples.

In another example, (U.S. Pat. No. 7,379,800, USA, 2006, Breed, D. S.), the approach of using the Hall effect to generate a measureable electrical signal was our desired approach, however, this patent only uses the method to measure tire pressure alone. This patent was abandonned by the owner. In conclusion, the concept of a fixed object within the tire rubber was used often in the Prior Art above. Similarly, the concept of a vehicle frame mounted transmitter or receiver was used often in the Prior Art above. Both methods were used primarily for monitoring the air pressure or physical condition of a tire, not relative to shear forces or compression forces that would provide the information required for our purposes. One patent offers an approach to measure friction forces, but the sensors will not have a long lifespan in the tire rubber due to friction related heat while the tire rotates on pavement in addition to sudden physical shocks due to irregularities in the road surface. Therefore, with the exception of the common physics principal of Hall effect to generate electrical signals, these methods are insufficient for our purposes and improvements are necessary to make tire condition sensing commercially viable. Our technology addresses these concens and overcomes the technical issues mentioned above.

Tire Motion and Hall Effect Sensor Measurements

The patent “Tire pressure monitoring using hall effect sensors” (U.S. Pat. No. 7,379,800, USA, 2006, Breed, D. S.) shares the general physics principle of hall effect in a tire application, somewhat comparable with our own patent. The similarities include a wheel assembly, with a tire pressure monitoring system, a magnet is placed at a fixed location within the tire interior surface. The rotation of the tire passes a sensor, mounted to the non-rotating part of the wheel assembly, thereby inducing electrical current, by sensing the magnetic field density of the magnet as the magnet passes the sensor, during each tire rotation. The vehicle tire rpm will average several hundred to several thousand, based upon the speed of the vehicle. However, in our patent, magnets of identical physical dimensions are placed with a specific distance from each other, in an north-south alignment, as a linear array, parallel to the grooves of a tire tread. The magnets are embedded in the tire rubber, during the tire manufacturing process. The magnets are placed within several mm of the exterior surface of the tire to maximize sensitivity to the shear strain and compressive strain forces. These two forces are measured by a non-rotating sensor that detects the magnetic field density of the magnet as the magnet passes the sensor. With the magnets in a linear array, detection of shear forces (X & Y axis data) and compression forces (Z axis data) within the tire, will be possible as the magnet array can provide a longer interval of information and measurement along a longer section of the tire surface than the previously mentioned patent. Our target sensor data measurements and method of magnet orientation, permanently affixed within the tire rubber, differentiate our concept from the previously mentioned patent.

Tire Motion, Environmental Error Sources and Data Fusion

No previous device has demonstrated the ability to adequately correct for errors, to improve signal quality. Namely, error correction to account for tire surface and/or environmental variations (e.g. icy road conditions) and/or noise and/or artifacts and/or electrical interference generated by the vehicle alternator electromagnetic field and/or electromagnetic interference from electric motor activation and deactivation in applications involving electric and/or hybrid motor vehicles and/or the electromagnetic interference resulting from passing vehicles, industrial facilities, electric power generating stations, powered cables underneath the road surface, magnetic geological formations underneath the road surface, or paramagnetic materials naturally occurring in random concentrations in the road bitumen. The elimination and/or minimization of these errors will further enhance the reliability of the final processed data. One critical feature is error correction—the removal of unwanted ambient noise, random spikes and artifacts is a necessary process for sensor data collection and analysis. In the case of nanotechnology based sensors, physically smaller than traditional solid metal probes or metal films, the nanoprobes measure the movement of a smaller density of electrons. Therefore, signal amplification is required. Unfortunately, signal amplification also increases noise proportionately with the original signal. Prior art examples demonstrate the growing importance of this process: (U.S. Pat. No. 8,972,196, USA, 2010, Peyser et al.), (U.S. Pat. No. 9,173,567, USA, 2013, Reinhardt), (U.S. Pat. No. 9,176,819, USA, 2011, Stergiou et al.), (U.S. Pat. No. 9,192,328, USA, 2009, Brauker et al.). Regular calibration and self-calibration are successful modes of error reduction, as noted in the following Prior Art: (U.S. Pat. No. 9,204,840, USA, 2008, Shin et al.), (U.S. Pat. No. 9,220,449, USA, 2013, Pryor et al.), (U.S. Pat. No. 9,311,801, USA 2014, Cholhan et al.), (U.S. Pat. No. 9,227,014, USA, 2014, Buckingham et al.) and (U.S. Pat. No. 9,226,701, USA, 2010, Sloan et al.) and an example of sensor fusion, which is an excellent concept by combining multiple sensor types to reduce error, but the Prior Art showed room for improvements as well (U.S. Pat. No. 9,224,311, USA, 2014, Yeh et al.).

Position, Location, Tracking, Motion Detection.

Another featuring increasing in demand, is a device that tracks a specific target, such as, the status of a vehicle and/or its individual parts. However, in various embodiments, this technology can be adopted to monitor other surfaces, environments and/or physical objects, such as, individual body parts (e.g. fingers, arms, legs, neck), gait, poise, physical condition (e.g. biometric data, rehabilitation status), geographic location. The tracking feature applies to objects (e.g. vehicles, packages, freight containers, smartphones, satelites, aeroplanes, boats, etc). The current and past technologies fall short on delivering stable, low-error, long term results and there is room for improvement. Examples of Prior Art that have expanded upon tracking and sensor monitoring features, with limited success, limited parameters and/or limited applications, include: (U.S. Pat. No. 9,307,922, USA, 2015, Kuppuraj et al.), (U.S. Pat. No. 9,256,910, USA, 2011, Goldberg et al.), (U.S. Pat. No. 9,317,983, USA, 2014, Ricci, C.), (U.S. Pat. No. 9,317,867, USA, 2015, Johnson et al.), (U.S. Pat. No. 9,215,980, USA, 2013, Tran et al.), (U.S. Pat. No. 9,316,731, USA, 2012, Ware et al.), (U.S. Pat. No. 9,314,167, USA, 2014, LeBoeuf et al.), (U.S. Pat. No. 9,313,233, USA, 2013, Sprague et al), (U.S. Pat. No. 9,298,883, USA, 2014, Kurtz et al.), (U.S. Pat. No. 9,311,789, USA, 2014, Gwin et al.), for the visually impaired (U.S. Pat. No. 9,311,827, USA, 2014, Alqahtani et al.), to monitor driver fatigue (U.S. Pat. No. 9,302,584, USA, 2014, Walsh et al.), to monitor muscle performance (U.S. Pat. No. 9,295,424, USA, 2011, Todorov et al.), monitor vital signs and body weight (U.S. Pat. No. 9,247,884, USA, 2014, Yuen et al.), and gyroscopes for fitness tracking devices (U.S. Pat. No. 9,168,419, USA, 2014, Hong et al.), muscular-skeletal correction in rehabilitation (U.S. Pat. No. 9,271,675, USA, 2014, Stein et al.) and movement detection to attach to equipment (U.S. Pat. No. 9,267,793, USA, 2014, Vock et al.).

Emergency Response.

Another feature increasing in demand, due to the increasing cost of insurance involving the operation and maintenance of a vehicle for personal, commercial or industrial environments (e.g increasing number of senion citizens driving vehicles with reduced reflex response, mining industries, construction, health-care, transportation, military, law enforcement, etc.), a cost-effective means of reducing insurance premiums and improving protection for vehicle users has become a priority. One solution applied in vehicles is a warning system consisting of an audio and/or visual and/or physical response to react and temporarily override a driver's control of a vehicle in order to reduce the risk of an accident. Another option is for the long-term application of driverless vehicles, in which the vehicle occupant has limited or no control over the physical movement of the vehicle except to plot a tragectory between a start point and end point, for travel—in this instance, the vehicle will be almost exclusively under the control of a computer system. The computer will require environmental and tire condition data with the highest degree of accuracy in order to calculate an informed decision to maximize safety for the occupant and the vehicle. The following examples of Prior Art demonstrate several attempts to address emergency response wearable sensor device, but offer limited capabilities, are bulky or are impractical in daily use: (U.S. Pat. No. 7,400,246, USA, 2006, Breeding, R.), (U.S. Pat. No. 8,294,568, USA, 2007, Barrett, J), (U.S. Pat. No. 9,256,711, USA, 2012, Horseman et al.) and (U.S. Pat. No. 9,293,023, USA, 2015, Zhang et al.).

Optimization of Energy Consumption.

Another critical feature, is the optimization of energy consumption, to maintain a small size for the device. In Prior Art, although limited in the product application, there exists room for improvement as well. Prior Art also demonstrates an increasing trend with the following examples: (U.S. Pat. No. 9,313,800, USA, 2009, Lepisto et al.), (U.S. Pat. No. 9,281,871, USA, 2012, Smith et al.), (U.S. Pat. No. 9,331,495, USA, 2010, Soar et al) and (U.S. Pat. No. 9,312,400, USA, 2011, Hassan et al.). Our product will further advance the optimization of energy for use in conventional internal combustion vehicles, hybrid-electric vehicles and fully electric vehicles (where energy optimization will be critical to the overall performance of the vehicle and range of the vehicle). With a long-term industry shift towards electric and hybrid vehicles, energy optimization will “future proof” our technology.

Energy Harvesting.

Another feature to further “future proof” our technology, is the ability to harvest energy from environmental sources, to power our device and/or contribute to the collective charging of the vehicle battery system. In one example of energy harvesting via tires (U.S. Pat. No. 4,504,761, USA, 1981, Triplett), Triplett demonstrated a means of generating electricity by mounting piezoelectric elements to a tire, with the premise that as the vehicle rotates during normal driving conditions, vibrations will induce electric current. This method takes advantage of flexion, shearing and compression to generate electricity. Our device incorporates multiple modes of energy harvesting, ranging from physical (piezoelectric, thermal) and electromagnetic radiation—mounted on the vehicle frame. The vehicle frame generates sufficient vibration while driving and movement of the vehicle as it passes stationary sources of electromagnetic radiation will induce currents in appropriate circuits for electricity harvesting. Placing piezoelectric sensors on the tire surface was deemed impractical and given the sensitivity of a piezoelectric device, sudden physical jolts will render a tire-mounted piezoelectric system inoperable within a short period of time, nor would it provide sufficient shear or compression information prior to failure.

### SUMMARY OF THE DISCLOSURE

This device employs 3D and/or 2D magnetic field measurement sensors and an array of magnets embedded in the tire, to provide information regarding the shear strain induced in tire at the contact area between the tire and the road by friction and compressive strain in the tire due to vertical load applied on the tire, and the data is transmitted wirelessly to a receiver. The device is an ultra-low power, one-way communication, magnetic tire monitoring multi-sensor system, a microprocessor, a signal amplifier, signal filtering, using error correction algorithms, an analog-to-digital converter and a wireless electromagnetic data transmitter to transmit to a remote receiver for further processing, using a computer network and wireless access points in fixed locations. The collected data is then employed to measure the real time friction force between the tire and the road during rotation of the tire when the sensor is in contact with the road. The device is powered by rechargeable battery via DC power supply from the vehicle. The device is placed near the tire surface for sensor measurement. Abrasion of the tire will monitored by the sensor and it will be able to work during the whole standard life of the tire. Instantaneous and continuous data collection are possible. The device can be installed inside the tire and the device will perform measurements during the normal performance of the vehicle. The data collected will be ready to transfer to an ECU (Electronic Control Unit) of a car to use as indication of the road condition for control proposes of conventional vehicles, as well as in driver-less (computer controlled) vehicles.

### BRIEF DESCRIPTION OF THE DRAWINGS

(Patent office note: drawings and descriptions are forthcoming)

### DESCRIPTION OF THE EMBODIMENTS

In other embodiments, the device may incorporate a vehicle diagnostic unit.

In other embodiments, the device may incorporate pattern recognition and/or neural network(s) and/or machine learning.

In other embodiments, the device may incorporate a control system to control other electrical and/or physical aspects of a vehicle.

In other embodiments, the device may incorporate RFID technology.

In other embodiments, the device may incorporate a plurality of sensors.

In other embodiments, the device may incorporate sensors (other than hall effect sensor) for the purposes of monitoring chemical, environmental, physical characteristics.

In other embodiments, the device may incorporate one or more methods of providing power to said device.

In other embodiments, the device may communicate with the OBD-II (On-Board Diagnostic Level II as required by the US Government for emission controls).

In other embodiments, the device may incorporate a means of electrical isolation from the main electrical system of the vehicle.

In other embodiments, the device may incorporate a method of encryption for the purposes of communicating data to a vehicle computer system.

In other embodiments, the device may incorporate a display and/or tactile controller system.

In other embodiments, the device may incorporate a method for heremtically sealing the device from the outside environment.

In other embodiments, the device may incorporate a method of software coding to differentiate wireless signals from different tires.

In other embodiments, the device may incorporate a methods of sensor fusion to improve upon signal quality.

In other embodiments, the device may incorporate multiple methods of error correction, signal filtering and/or signal enhancement.

In other embodiments, the device may incorporate a magnet arrays in any position within the tire rubber.

In other embodiments, the device may incorporate multiple magnet arrays in any position(s) within the tire rubber.

In other embodiments, the device may be used on any object, other than a vehicle (for example, but not limited to, rotors, gears, mechanical assemblies, turbines, belts, etc).

In other embodiments, the device may be used to collect any physical and/or environmental and/or electromagnetic data beyond the scope mentioned in this patent.

1. The device is an ultra-low power, one-way communication, magnetic tire monitoring multi-sensor system, a microprocessor, a signal amplifier, signal filtering, error correction algorithms, analog-todigital converter and wireless electromagnetic data transmitter to a remote device for further processing, using a computer network and wireless access points in fixed locations. This access point will translate the data to be ready to communicate with ECU. In addition, collected data can be represented visually on a remote base-station computer (handheld, smart-phone, desktop, laptop, etc.) via software, and for storage in a database.

2. The device, indicated in claim #1, consists of two components: a) an array of magnets and; b) a sensor containing a microprocessor and communication system.

3. The device, indicated in claim #2a, contains a magnet of specific phyiscal dimensions.

4. The device, indicated in claim #2a, contains multiple magnets with specific distances between said magnets.

5. The device, indicated in claim #2a, forms a linear array consisting of of multiple magnets.

6. The device, indicated in claim #2a, must be located on a moving part of the vehicle, namely, a tire.

7. The device, indicated in claim #2a, as a linear array of magnets, shall be permanently embedded in the tire rubber, during the tire manufacturing process.

8. The device, indicated in claim #2a, is located several mm from the exterior surface of the tire.

9. The device, indicated in claim #2a, is not be exposed to the environment outside of the tire rubber.

10. The device, indicated in claim #2a, do not require electricity to generate and/or maintain a magnetic field.

11. The device, indicated in claim #2b, also consists of a device that is mounted to the non-moving part of the vehicle, with the sensor facing the axial plane exterior surface of the tire.

12. The device, indicated in claim #2b, contains a sensor, for example, a Hall effect sensor.

13. The sensor, indicated in claim #2b, is placed near the tire surface for measurement purposes.

14. The device, indicated in claim #2b, shall be powered by ambient thermoelectric and/or electromagnetic radiation and/or direct connection to the vehicle electrical system.

15. The device, indicated in claim #2b, is capable of single and continuous data collection.

16. The device, indicated in claim #2b, contains an analog to digital converter, microprocessor and communication system (hard-wired and/or wireless).

17. The device, indicated in claim #2b, contains error correcting software coding to improve accuracy and signal quality.

18. The device, indicated in claim #2b, has ultra-low power requirements for energy efficiency.

19. The device, indicated in claim #2b, transmits the collected data wirelessly to a remote computer (handheld, smart-phone, desktop, laptop, etc.), where the collected data is visually represented via software.

20. The device, indicated in claim #1, can be reused repeatedly.
